(19) United States
(12) Patent Application Publication
(10) Pub. No.: US 2025/0065745 A1
(43) Pub. Date: Feb. 27, 2025

(54) POWER CONNECTOR INTERLOCK SYSTEM

(71) Applicant: Oshkosh Corporation, Oshkosh, WI (US)

(72) Inventors: David Lombardo, Oshkosh, WI (US); Bogdan Marinoiu, Oshkosh, WI (US)

(21) Appl. No.: 18/814,233

(22) Filed: Aug. 23, 2024

Related U.S. Application Data
(60) Provisional application No. 63/578,597, filed on Aug. 24, 2023.
(60) Provisional application No. 63/682,959, filed on Aug. 14, 2024.

(51) Int. Cl. B60L 53/60; B60L 53/16

(52) U.S. Cl. CPC B60L 53/60; B60L 53/16; B60L 2200/40; B60L 2240/28

(57) ABSTRACT

A vehicle includes an energy storage device, a door configured to move between an open position and a closed position relative to the vehicle, an onboard power connector electrically coupled with the energy storage device, and a controller. An external power connector electrically coupled with an external power source is configured to couple with the onboard power connector to facilitate transferring electrical energy from the external power source to the energy storage device. The controller is configured to monitor a position of the door and limit the transfer of electrical energy from the external power source to the energy storage device when (i) the external power connector is coupled with the onboard power connector and (ii) the door is in the open position.

### CROSS-REFERENCE TO RELATED PATENT APPLICATIONS

This application claims the benefit of and priority to U.S. Provisional Application No. 63/578,597, filed on Aug. 24, 2023 and U.S. Provisional Patent Application No. 63/682,959, filed on Aug. 14, 2024, the entire disclosures of which are hereby incorporated by reference herein.

### BACKGROUND

The present disclosure relates to lift devices. More specifically, the present disclosure relates to charging lift devices.

### SUMMARY

On embodiment relates to a vehicle. The vehicle includes an energy storage device, a door configured to move between an open position and a closed position relative to the vehicle, an onboard power connector electrically coupled with the energy storage device, and a controller. An external power connector electrically coupled with an external power source is configured to couple with the onboard power connector to facilitate transferring electrical energy from the external power source to the energy storage device. The controller is configured to monitor a position of the door and limit the transfer of electrical energy from the external power source to the energy storage device when (i) the external power connector is coupled with the onboard power connector and (ii) the door is in the open position.

Another embodiment relates to a control system for a vehicle. The vehicle includes a one or more processing circuits configured to determine, responsive to detection of a connector, that the vehicle is electrically coupled with a power source via the connector, the power source configured to provide power to charge a battery of the vehicle, receive, via the connector, from the power source, a first signal to initiate charging of the battery, transmit, via the connector, to the power source, a second signal to indicate a first plurality of parameters to define a first amount of power to receive from the power source, electrically couple, via the connector, the battery with the power source to charge the battery using the first amount of power, detect that a component of the vehicle has moved from a first position to a second position, and transmit, via the connector, to the power source, a third signal to indicate a second plurality of parameters to define a second amount of power to receive from the power source.

Still another embodiment relates to a method for charging a vehicle. The method includes providing the vehicle including an energy storage device, an onboard power connector electrically coupled with the energy storage device, and a door configured to move between an open position and a closed position relative to the vehicle to provide selective access to the onboard power connector, monitoring a position of the door, determining whether the door is in the open position or the closed position, determining whether an external power connector is coupled with the onboard power connector, wherein the external power connector is electrically coupled with an external power source, and limiting the transfer of electrical energy from the external power source to the energy storage device based on a determination that (i) the external power connector is coupled with the onboard power connector and (ii) the door is in the open position.

### BRIEF DESCRIPTION OF THE DRAWINGS

FIG. 1 is a perspective view of a lift device, according to some embodiments.

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of a platform assembly of the lift device of FIG. 1, according to some embodiments.

FIG. 5 is a side view of the lift device of FIG. 1 including a door in an open position and a plurality of sensors, according to some embodiments.

FIG. 6 is a perspective view of the lift device of FIG. 1 including a sensor and a bracket assembly, according to some embodiments.

FIG. 7 is a side view of the sensor and bracket assembly of FIG. 6 with the door in the open position, according to some embodiments.

FIG. 8 is a side view of the sensor and bracket assembly of FIG. 6 with the door in a closed position, according to some embodiments.

FIG. 9 is a perspective view of a sensor of the lift device of FIG. 1, according to some embodiments.

FIG. 10 is a front view of a power connector interlock system of the lift device of FIG. 1 with the door in the open position, according to some embodiments.

FIG. 11 is a front view of the power connector interlock system of FIG. 10 with the door in the closed position, according to some embodiments.

FIG. 12 is a diagram of the power connector interlock system of FIG. 10, according to some embodiments.

FIG. 13 is a diagram of the power connector interlock system of FIG. 10 including a relay system, according to some embodiments.

FIG. 14 is a flow diagram of a method for charging the lift device of FIG. 1, according to some embodiments.

FIG. 15 is a block diagram of a system to control charging of a battery, according to some embodiments.

FIG. 16 is a block diagram including a schematic block diagram of one or more components for a machine power system, according to some embodiments.

FIG. 17 is a sequence diagram of a process to control charging of a battery for a machine, according to some embodiments.

FIG. 18 is a sequence diagram of a process to control charging of a battery for a machine, according to some embodiments.

FIG. 19 is a sequence diagram of a process to control charging of a battery for a machine, according to some embodiments.

FIG. 20 is a sequence diagram of a process to control charging of a battery for a machine, according to some embodiments.

FIG. 21 is a schematic block diagram including one or more components of the system illustrated in FIG. 16, according to some embodiments.

FIG. 22 is a schematic block diagram including one or more components of the system illustrated in FIG. 16, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a lift device includes a power connector interlock system that is configured to selectively prevent a transfer of electrical energy from an external power source to an internal energy storage system of the lift device during charging operations. The power connector interlock system includes a door that is pivotable between an open position and a closed position. The power connector interlock system further includes a sensor configured to monitor a position of the door and provide a signal indicative of the position of the door. The external power source is configured to selectively prevent the transfer of electrical energy to the internal energy storage system (e.g., halt charging operations) based on the signal indicating that the door is in the open position. The power connector interlock system prevents electrical arcing that occurs in other power connector interlock systems during charging operations.

### Lift Device

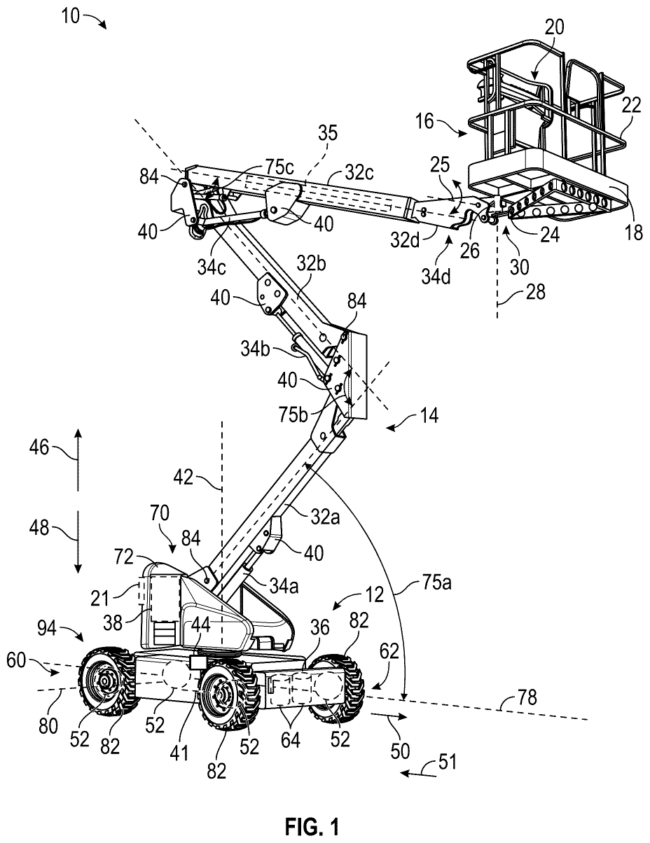

Referring to FIG. 1, a work machine, a lifting apparatus, lift device, or mobile elevating work platform (MEWP) (e.g., a telehandler, an electric boom lift, a towable boom lift, a lift device, a fully electric boom lift, a scissor lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward facing end, a front portion, a front, etc.), shown as front 62, and a rear end (e.g., a rearward facing end, a back portion, a back, a rear, etc.,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

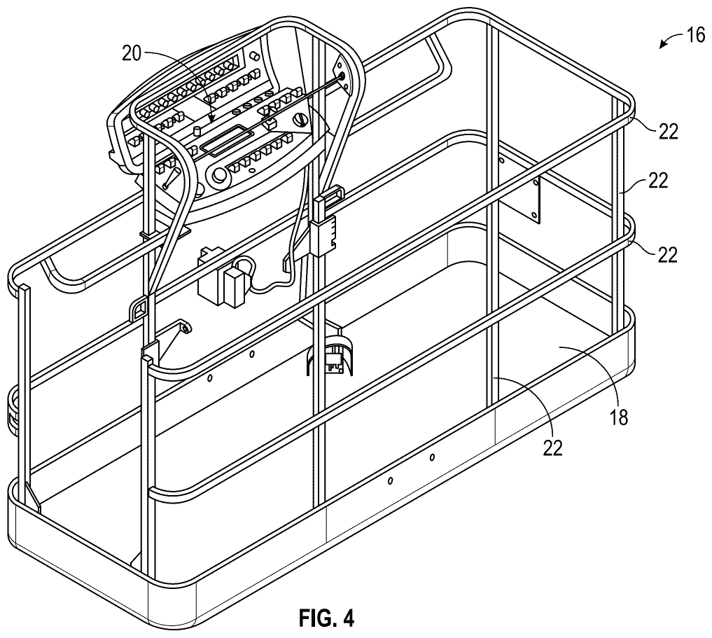

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

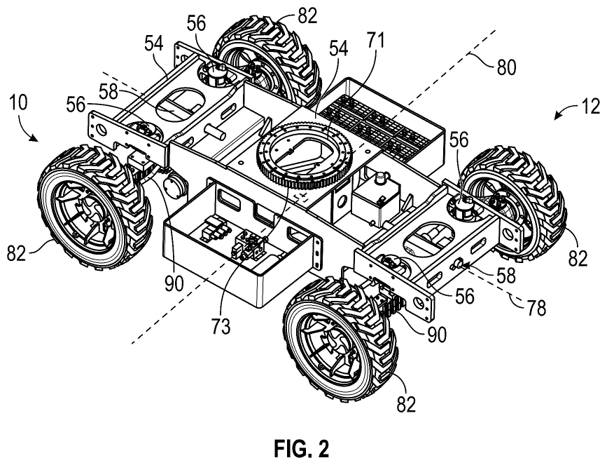

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 94. The steering system 94 is configured to drive tractive elements 82 to pivot for a turn of the lift device 10. The steering system 94 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

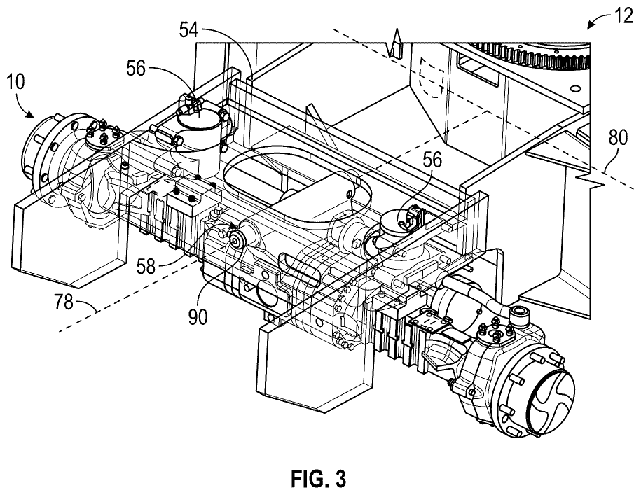

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 90 (e.g., axles, frame members, beams, bars, etc.) at opposite longitudinal ends of the longitudinally extending frame member 54. For example, the lateral frame members 90 may be pivotally coupled with the longitudinally extending frame member 54 at a front end and a rear end of the longitudinally extending frame member 54. The lateral frame members 90 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 90 (e.g., a front lateral frame member 90 or a rear lateral frame member 90) or the longitudinally extending frame member 54 and the receiving portion is coupled to the other of the longitudinally extending frame member 54 and the lateral frame member 90. For example, the pin may be coupled with longitudinally extending frame member 54 and the receiving portion can be coupled with one of the lateral frame members 90 (e.g., integrally formed with the front lateral frame member 90).

In some embodiments, the longitudinally extending frame member 54 and the lateral frame members 90 are integrally formed or coupled (e.g., fastened, welded, riveted, etc.) to define the base 36. In still other embodiments, the base 36 is integrally formed with the longitudinally extending frame member 54 and/or the lateral frame members 90. In still other embodiments, the base 36 is coupled with the longitudinally extending frame member 54 and/or the lateral frame members 90.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 90. When the axle actuators 56 extend, an end of a rod of the levelling actuators can contact the surface of lateral frame member 90 and prevent relative rotation between lateral frame member 90 and longitudinally extending frame member 54. In this way, the relative rotation/pivoting between the lateral frame member 90 and the longitudinally extending frame member 54 can be locked (e.g., to prevent rolling of the longitudinally extending frame member 54 relative to the lateral frame members 90 during operation of the lift assembly 14). The axle actuators 56 can receive power from the batteries 64, which can allow the axle actuators 56 to extend or retract. The axle actuators 56 receive control signals from controller 38.

### Power Connector Interlock System

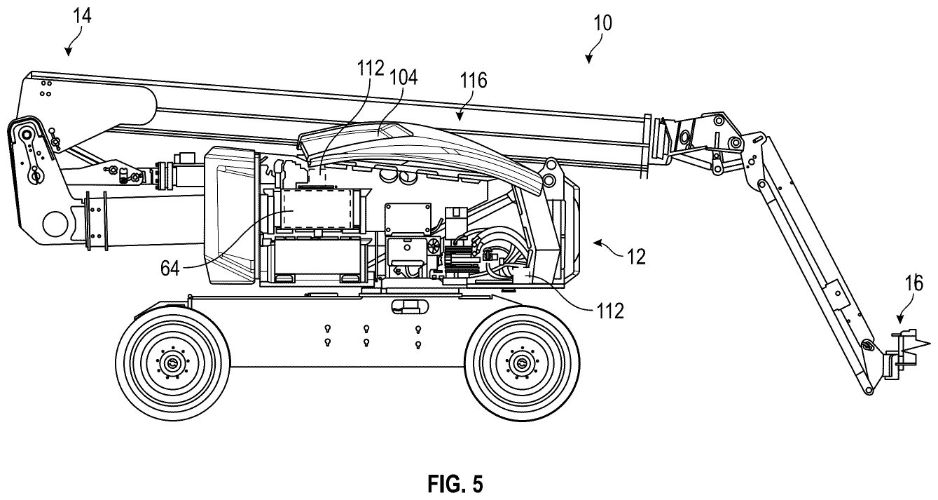

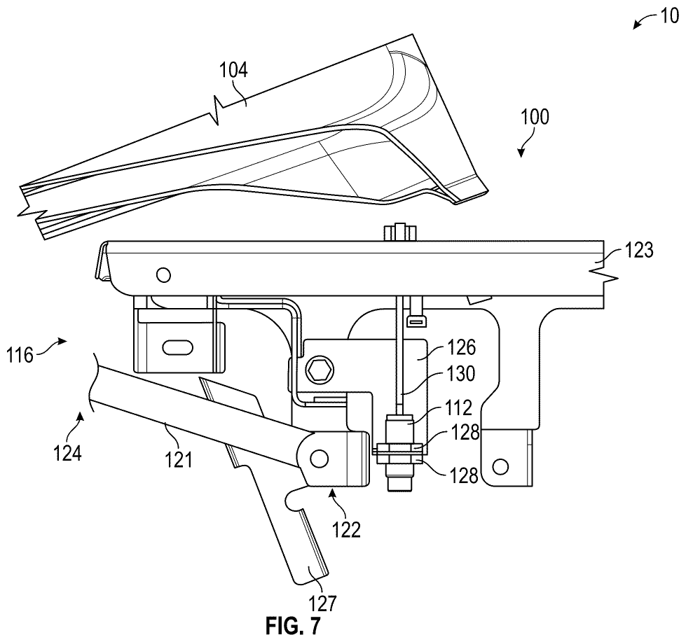

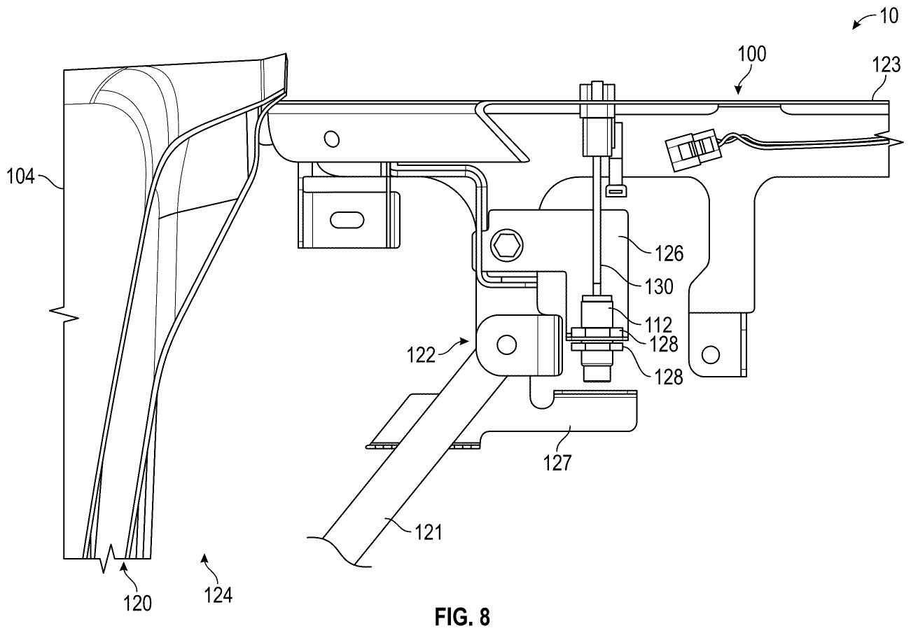

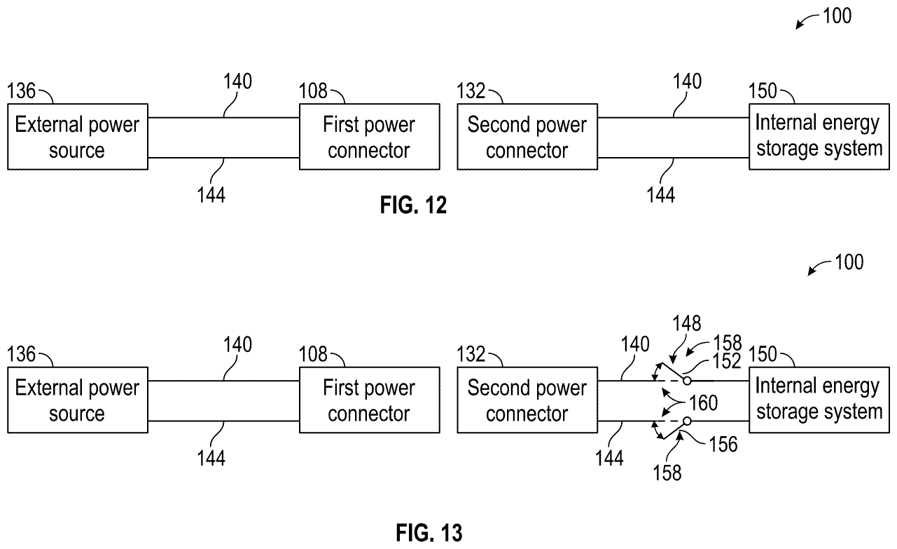

As shown in FIGS. 5-13, the lift device 10 includes a charging system, power transfer system, power connector interlock system, etc., shown as system 100. In some embodiments, the system 100 is incorporated into a vehicle, such as a lifting apparatus, lift device, MEWP (e.g., a telehandler, an electric boom lift, a towable boom lift, a lift device, a fully electric boom lift, a scissor lift, etc.), a forestry vehicle, a passenger vehicle (e.g., a bus), a boat, a refuse vehicle, an emergency response vehicle (e.g., a firetruck), a military vehicle, a mixer, or another type of vehicle. As shown in FIGS. 5-13, the system 100 includes a door 104 (e.g., switch, activator, hood, etc.), a first power connector 108 (e.g., an external power connector, contact plate, charging plate/pad, male connector, female connector, plug, terminal, etc.), a sensor 112 (e.g., proximity sensor, proximity switch, contact sensor, position sensor, etc.), a second power connector 132 (e.g., an onboard power connector, contact plate, charging plate/pad, female connector, male connector, plug, terminal, etc.) configured to electrically couple with the first power connector 108 to facilitate charging the lift device 10 (e.g., charging the batteries 64 thereof), and an energy storage and power source system (e.g., batteries, capacitors, etc.), shown as internal energy storage system 150, configured to store energy and provide power to one or more components of the lift device 10. In some embodiments, the system 100 includes the controller 38. The system 100 generally facilitates power communication between an external power source (e.g., external power source 136) and the internal energy storage system 150 (e.g., batteries 64) of the lift device 10 and/or any of the motors, sensors, actuators, electric linear actuators, electrical devices, electrical movers, stepper motors, etc., of the lift device 10. The system 100 is configured to control (e.g., permit, prevent, limit, etc.) power flow through the first power connector 108 from the external power source 136 to the internal energy storage system 150 (e.g., based on a position of the door 104). The sensor 112 is configured to detect a presence of (e.g., proximity of, contact with, position of, etc.) the door 104 and provide a signal (e.g., raw sensor data, varying voltage levels, varying current levels, digital signal, etc.) that may be associated with or include an indication of a state (e.g., condition, mode, position) of the door 104.

As shown in FIGS. 5, 7, 8, 10, and 11 the door 104 is positioned along an exterior surface or side of the lift device 10. In some embodiments, the door 104 is positioned on any side or surface of the lift device 10 (e.g., on the base assembly 12, on the lift assembly 14, on the platform assembly 16, etc.). As shown in FIGS. 5, 7, 8, 10, and 11, the door 104 is pivotably coupled to the lift device 10 such that the door 104 pivots (e.g., moves, actuates) between an open position 116 and a closed position 120. Similarly, the door 104 is pivotable between the closed position 120 and the open position 116. In some embodiments, the door 104 opens and closes by way of a different mechanism (e.g., slides open and closed). The door 104 is configured to provide selective access to the second power connector 132, the prime mover 41, the electric motor 52, the batteries 64, and/or one or more other components of the lift device 10 (e.g., the data cable 130, the first power cable 140, the second power cable 144, one or more other components housed within the base assembly 12, one or more components used to charge the lift device 10, etc.).

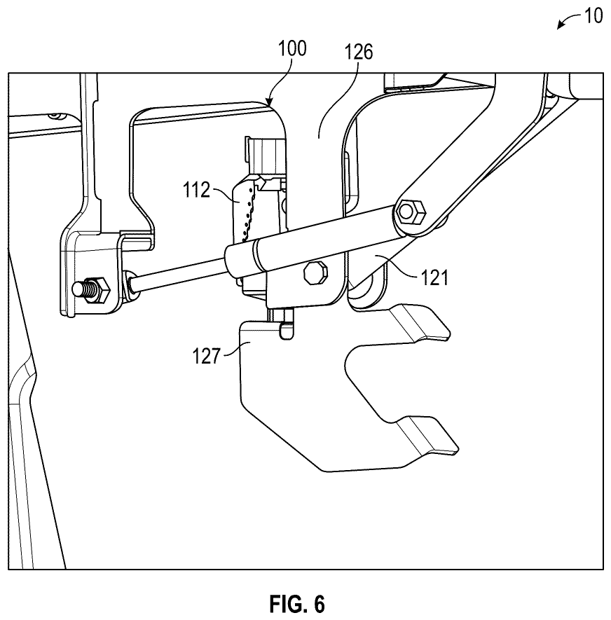

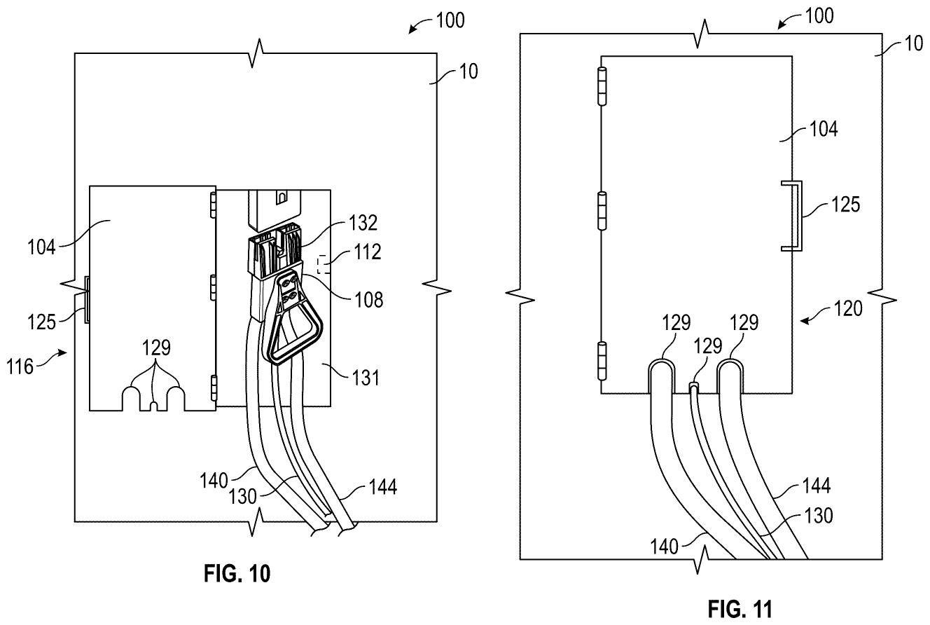

As shown in FIGS. 6-8, the door 104 is pivotably coupled to the lift device 10 by way of a support structure (e.g., arm, actuator), shown as arm 121. The arm 121 defines a first end 122 pivotably coupled to a frame member 123 (e.g., rigid member, structural support member, axle, base, frame, carriage, chassis, the base 36, the frame member 54, etc.) of the lift device 10, and a second end 124 opposite the first end 122 that couples the door 104 to the arm 121. As the door 104 is moved from the open position 116 to the closed position 120, or from the closed position 120 to the open position 116, (e.g., collectively, between the open position 116 and the closed position 120) the arm 121 pivots about the first end 122 coupled to the frame member 123 and repositions the door 104 relative to the lift device 10. In some embodiments, the door 104 is coupled to the lift device 10 by way of a different mechanism (e.g., hinges) configured to reposition the door 104 relative to the lift device 10. In some embodiments, the door 104 includes a handle 125 for an operator to grasp and move the door 104 between the open position 116 and the closed position 120. As shown in FIGS. 10 and 11, the door 104 defines a plurality of cutouts 129 (e.g., apertures, openings, etc.) through which cables (e.g., the data cable 130, the first power cable 140, the second power cable 144, etc.) may feed (e.g., pass) through when the door 104 is in the closed position 120 (and the first power connector 108 is coupled with the second power connector 132). When the first power connector 108 is coupled with the second power connector 132 and the door 104 is in the closed position 120, the door 104 inhibits access to the first power connector 108. In other words, in the closed position 120, the door 104 inhibits the operator from connecting/disconnecting the first power connector 108 with/from the second power connector 132, and, in the open position 116, the door 104 permits the operator to connect/disconnect the first power connector 108 with/from the second power connector 132.

As shown in FIGS. 6-8, the system 100 includes a bracket assembly including a first bracket 126 (e.g., linkage, support member, sensor support, etc.) and a second bracket 127 (e.g., interference member, linkage, flange, sensor block, etc.). The first bracket 126 is coupled to the frame member 123 and is configured to couple the sensor 112 to the lift device 10. The first bracket 126 defines an aperture through which the sensor 112 is threaded (e.g., slotted, placed, positioned). The sensor 112 is threaded through the aperture and selectively tightened into place by a set of nuts 128. The nuts 128 may be tightened to prevent or inhibit the sensor 112 from unintentionally loosening or repositioning (e.g., during operation of the lift device 10), which may adversely affect the performance of the intended function of the sensor 112. Before tightening the nuts 128, the sensor 112 may be threaded through the aperture of the first bracket 126 and through the nuts 128 to position the sensor 112 at a desired position (e.g., to optimize the performance of the intended function of the sensor 112, such that the sensor 112 is positioned to detect a state of the door 104, etc.). In some embodiments, the sensor 112 is otherwise coupled to the lift device 10, or any other component thereof (e.g., dedicated slots, hooks, tabs, pockets, clips, without using the nuts 128 and threaded aperture, etc.).

As shown in FIGS. 5, 7, 8, and 10, the sensor 112 is coupled to the lift device 10 proximate the door 104. The sensor 112 is positioned and configured to detect the state (e.g., position, location, proximity, etc.) of the door 104 relative to the lift device 10. As shown in FIGS. 6-8, the second bracket 127 is coupled to the arm 121 such that when the door 104 opens and closes, the second bracket 127 moves with the arm 121 and the door 104 relative to the lift device 10 (e.g., a position of the second bracket 127 is fixed relative to the arm 121 and the door 104). The second bracket 127 extends from the arm 121 such that, when the door 104 is in the closed position 120, the sensor 112 detects the second bracket 127. In the open position 116, the second bracket 127 is coupled to and positioned relative to the arm 121 and the door 104 such that the sensor 112 does not detect the presence of the second bracket 127. In the absence of a detection of the second bracket 127 (e.g., indicative of the door 104 being in the open position 116, indicative of the door 104 not being in the closed position 120), the sensor 112 may transmit a signal associated with an indication of the state of the door 104 in the open position 116. In some embodiments, the sensor 112 may not detect the presence of the second bracket 127 until the door 104 is in the closed position 120 (e.g., a fully closed position). In other words, the sensor 112 may transmit a signal associated with an indication that the door 104 is in the open position 116 unless the door 104 is in the closed position 120. In the closed position 120, the second bracket 127 is coupled to and positioned relative to the arm 121 and the door 104 such that the sensor 112 detects the presence of the second bracket 127. Responsive to a detection of the second bracket 127 (e.g., when the door 104 is in the closed position 120) by the sensor 112, the sensor 112 transmits a signal associated with an indication of the state of the door 104 in the closed position 120. In some embodiments, the sensor 112 includes an infrared switch that transmits infrared light and includes a photodetector configured to detect any reflections of the infrared light to detect the presence or absence of the second bracket 127. In some embodiments, the sensor 112 includes an inductive switch configured to detect a distance the sensor 112 is from the second bracket 127 by generating magnetic fields and detecting a change in current.

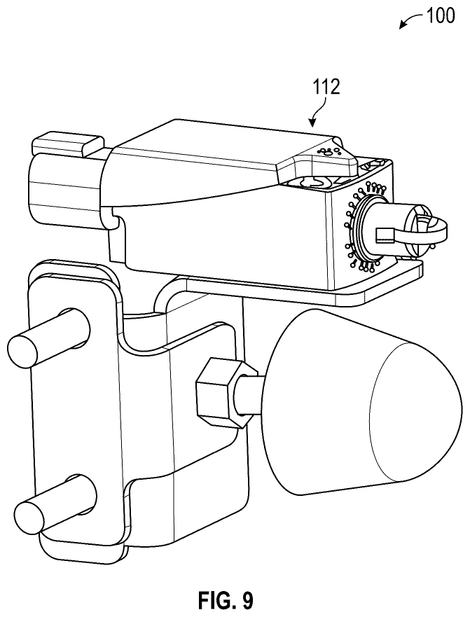

As shown in FIG. 9, the sensor 112 includes a limit switch (e.g., a position sensor, a mechanical switch, etc.) configured to detect a position of the door 104. The sensor 112 may be positioned along the lift device 10 such that the door 104 (or a portion thereof) is configured to contact (e.g., engage with, press, etc.) the sensor 112 in the closed position 120. By way of example, when the door 104 (e.g., a portion thereof) or another component of the lift device 10 comes into contact with the sensor 112, a determination may be made that the door 104 is in the closed position 120.

In some embodiments, the sensor 112 is positioned or mounted directly or indirectly to the lift device 10 in any conventional manner, provided the sensor 112 can detect the state of the door 104. In some embodiments, the system 100 includes more than one sensor 112 that collectively operate to detect the state of the door 104. The sensor 112 may be and/or include a motion sensor, a proximity sensor, a position sensor, and/or other possible sensors and/or other devices. For example, the sensor 112 may be positioned on the lift device 10 to detect whether the door 104 is in the open position 116, the closed position 120, and/or any position therebetween relative to the lift device 10. In another example, when the door 104 is in the open position 116, the sensor 112 detects an absence of the door 104, and when the door 104 is in the closed position 120, the sensor 112 detects the presence of the door 104. In yet another example, the sensor 112 monitors a distance the door 104 is relative to the lift device 10, and transmits a signal associated with the distance to the controller 38 to determine whether the door 104 is in the open position 116 or the closed position 120. Responsive to detecting the state of the door 104, the sensor 112 provides (e.g., transmits) a signal (e.g., raw sensor data, varying voltage levels, varying current levels, digital signal, etc.) that may be associated with or include an indication of the state of the door 104. For example, the signal may be based on or indicate that the door 104 is in the open position 116, the closed position 120, and/or any position therebetween relative to the lift device 10. The sensor 112 may transmit the signal associated with the indication of the state of the door 104 through a wired connection, shown as data cable 130, or a wireless connection to the controller 38. When the door 104 is in the closed position 120, the data cable 130 may feed through one of the cutouts 129 of the door 104.

Referring to FIG. 10, the system 100 includes a power connector housing, cable housing, etc., shown as housing 131. The housing 131 defines an interior chamber in which the second power connector 132 is disposed. In some embodiments, the second power connector 132 is positioned proximate the batteries 64 to reduce power losses during charging operations (e.g., by reducing electrical resistance that increases with a distance between the second power connector 132 and the batteries 64) and therefore improve overall charging efficiency. As shown in FIG. 10, the first power connector 108 is configured to electrically connect with (e.g., plug into, fit into, receive, interface with, etc.) the second power connector 132 such that the first power connector 108 provides power communication between an external power source 136 and the second power connector 132. By way of example, the first power connector 108 may be manipulated and repositioned by an operator to couple the first power connector 108 with the second power connector 132. The external power source 136 may be a power grid, generator, external battery, or any other source of power. In some embodiments, the external power source 136 may be coupled to a source of power, such as a power grid, generator, or battery. In some embodiments, the external power source 136 is communicably coupled to the controller 38 to facilitate wireless communication between the lift device 10 and the external power source 136. For example, the wireless communication may include any combination of a wireless network transceiver (e.g., Bluetooth® transceiver, cellular modem, a Wi-Fi® transceiver) and/or wired network transceiver (e.g., an Ethernet transceiver). In some embodiments, the lift device 10 includes hardware and machine-readable media structured to support communication over multiple channels of data communication (e.g., wireless, Bluetooth®, near-field communication, etc.) to facilitate wireless communication. In yet other embodiments, the lift device 10 includes one or more cryptography modules to establish a secure communication session (e.g., using the IPSec protocol or similar) in which data communicated over the session is encrypted and securely transmitted.

Responsive to the second power connector 132 and the first power connector 108 being coupled together, the external power source 136 and the internal energy storage system 150 (e.g., batteries 64) of the lift device 10 may be in power communication with each other (e.g., the external power source 136 can provide energy to the internal energy storage system 150). In some embodiments, the second power connector 132 is configured to facilitate delivering power directly to any of the motors, sensors, actuators, electric linear actuators, electrical devices, electrical movers, stepper motors, etc., of the lift device 10 (e.g., via the first power cable 140 and the second power cable 144). The batteries 64 are configured to charge (e.g., fast charge) by receiving electrical energy (e.g., DC-DC charging power) from the external power source 136.

As shown in FIGS. 10-13, the first power connector 108 and the second power connector 132 include a wired cable assembly, shown as first power cable 140 and second power cable 144. The first and second power cables 140, 144 are configured to transfer the electrical energy from the external power source 136 to the lift device 10. The first power cable 140 may be a positive terminal (e.g., a first conductor, DC fast charging B+ cable) and the second power cable 144 may be a negative terminal (e.g., a second conductor, DC fast charging B-cable). Placing the first power connector 108 in electrical communication with the second power connector 132 facilitates electrical communication between the external power source 136 and the internal energy storage system 150 (e.g., through an inverter or other power converter that converts electrical energy between alternating current and direct current). Accordingly, current generated can be transmitted to the batteries 64 to charge the batteries 64. In some embodiments, a single cable is used instead of the first and second power cables 140, 144 to transfer the electrical energy from the external power source 136 to the lift device 10 or any one or more components of the lift device 10 (e.g., motors, sensors, actuators, electric linear actuators, electrical devices, electrical movers, stepper motors, etc.).

An operator may access the second power connector 132 when the door 104 is in the open position 116, or partially open, to electrically connect the first power connector 108 to the second power connector 132. In some embodiments, the first power connector 108 is disposed (e.g., housed) within a handle (e.g., plug) to aid the operator in electrically connecting the first power connector 108 to the second power connector 132. The handle may be ergonomically shaped for the operator to hold in their hand. The handle may be manufactured from a durable high-strength plastic (e.g., polycarbonate, acrylonitrile butadiene styrene, polyphenylene ether, etc.) and may include an insulation member (e.g., coating) to protect the operator during charging operations. In some embodiments, the handle is manufactured from any other suitable material. When the door 104 is in the closed position 120, the first and second power cables 140, 144 may feed through one or more of the cutouts 129 defined by the door 104.

In some embodiments, the external power source 136 is configured to selectively prevent and permit power transfer to the internal energy storage system 150 (e.g., prevent or permit charging the batteries 64). The sensor 112 is configured to transmit the signal associated with the indication of the state of the door 104 through a wired connection (e.g., via the data cable 130) or a wireless connection to the controller 38. In some embodiments, responsive to receiving the signal from the sensor 112, the controller 38 determines whether the door 104 is in the open position 116, the closed position 120, and/or any position therebetween. By way of example, the controller 38 is configured to use information from the sensor 112 to determine the state of the door 104. Responsive to a determination from the sensor 112 or the controller 38 that the door 104 is in the open position 116, the sensor 112 or the controller 38 automatically provides a signal, through wired or wireless communication, commanding the external power source 136 to prevent power transfer to the internal energy storage system 150. By way of example, when (i) the door 104 is in the open position 116 and (ii) when the first power connector 108 is (a) in electrical communication with the second power connector 132 or (b) not in electrical communication with the second power connector 132, the transfer of electrical energy from the external power source 136 to the internal energy storage system 150 is prevented (e.g., charging operations are stopped). In other words, regardless of whether or not the first power connector 108 is in electrical communication with the second power connector 132, the transfer of electrical energy from the external power source 136 to the internal energy storage system 150 is prevented when the door 104 is in the open position 116. Responsive to a determination from the sensor 112 or the controller 38 that the door 104 is in the closed position 120, the sensor 112 or the controller 38 automatically provides a signal, through wired or wireless communication, commanding the external power source 136 to permit power transfer to the internal energy storage system 150. By way of example, when (i) the door 104 is in the closed position 120, and (ii) when the first power connector 108 is in electrical communication with the second power connector 132, the transfer of electrical energy from the external power source 136 to the internal energy storage system 150 is permitted (e.g., charging operations may commence). To disconnect the first power connector 108 from the second power connector 132 while charging operations are in progress, the operator may first move the door 104 to the open position 116, which stops the charging operations, then the operator may disconnect the first power connector 108 from the second power connector 132.

In some embodiments, the controller 38 is configured to detect whether the first power connector 108 is in electrical communication and/or in contact with the second power connector 132. By way of example, the controller 38 may receive a signal (e.g., varying voltage levels, varying current levels, etc.) in response to the first power connector 108 contacting the second power connector 132.

The sensor 112 or the controller 38 may provide the signal associated with the indication of the state of the door 104 for the user interface 20 and/or the user interface 21 to display. By way of example, the operator may utilize the displayed signal to determine the state of the door 104. By way of another example, the controller 38 may analyze the signal and autonomously notify the operator (through the user interface 20 or the user interface 21) of (i) the state of the door 104 and/or (ii) a status of charging operations (e.g., whether the transfer of electrical energy from the external power source 136 to the internal energy storage system 150 is prevented or permitted).

According to an exemplary embodiment shown in FIG. 13, a relay system 148 may be positioned between the second power connector 132 and the internal energy storage system 150 (e.g., batteries 64) of the lift device 10 and may be configured to selectively prevent and permit power transfer between the second power connector 132 and the internal energy storage system 150 (e.g., prevent or permit charging the batteries 64). The relay system 148 includes a first relay 152 (e.g., switch, pin, etc.) provided along the first power cable 140 between the second power connector 132 and the internal energy storage system 150. The relay system 148 further includes a second relay 156 (e.g., switch, pin, etc.) provided along the second power cable 144 between the second power connector 132 and the internal energy storage system 150. The first relay 152 and/or the second relay 156 may be or include an electromechanical relay, a solid-state relay, a reed relay, a polarized relay, or any other relay configured to selectively prevent power transfer between the second power connector 132 and the internal energy storage system 150. The first and second relays 152, 156 are configured to pivot between an open position 158 to open a power circuit (e.g., prevent current flow) and a closed position 160 to close the power circuit (e.g., permit current flow). In the open position 158, the first and second relays 152, 156 prevent the transfer of power between the second power connector 132 and the internal energy storage system 150. In the closed position 160, the first and second relays 152, 156 permit the transfer of power between the second power connector 132 and the internal energy storage system 150. In some embodiments, the relay system 148 includes one relay that pivots to open or close the power circuit and prevent or permit, respectively, the power transfer between the second power connector 132 and the internal energy storage system 150. Similarly, when the first power connector 108 and the second power connector 132 are electrically connected, the relay system 148 is configured to prevent and permit the transfer of electrical energy from the external power source 136 to the internal energy storage system 150 (e.g., prevent and permit charging the batteries 64). In some embodiments, the relay system 148 is positioned between the external power source 136 and the first power connector 108. In some embodiments, the system 100 utilizes systems or components other than the relay system 148 to prevent or permit the transfer of electrical energy from the external power source 136 to the internal energy storage system 150. For example, the system 100 may utilize any one or more of a switch, an actuator, a contactor, etc. to manually or automatically open or close the power circuit to prevent or permit the transfer of electrical energy from the external power source 136 to the internal energy storage system 150. In some embodiments, the system 100 does not include the relay system 148.

According to an exemplary embodiment, responsive to a determination from the sensor 112 or the controller 38 that the door 104 is in the open position 116, the sensor 112 or the controller 38 automatically provides a signal commanding the relay system 148 to move the first relay 152 and/or the second relay 156 to the open position 158. By way of example, when (i) the door 104 is in the open position 116 and (ii) when the first power connector 108 is (a) in electrical communication with the second power connector 132 or (b) not in electrical communication with the second power connector 132, the transfer of electrical energy from the external power source 136 to the internal energy storage system 150 is prevented (e.g., charging operations are stopped). Responsive to a determination from the sensor 112 or the controller 38 that the door 104 is in the closed position 120, the sensor 112 or the controller 38 automatically provides a signal commanding the relay system 148 to move the first relay 152 and/or the second relay 156 to the closed position 160. By way of example, when (i) the door 104 is in the closed position 120 and (ii) when the first power connector 108 is in electrical communication with the second power connector 132, the transfer of electrical energy from the external power source 136 to the internal energy storage system 150 is permitted (e.g., charging operations may commence).

The system 100 of the present disclosure provides various advantages over other charging systems. Electrical arcing can occur in other charging systems when a voltage across a gap (e.g., across an electrical connection between two power connectors) becomes high enough and a surrounding area (e.g., air, gas, etc.) ionizes. The ionized area permits electric current to flow across the gap which creates an electric arc that produces heat, shocks, fires, etc. that may damage the charging system and/or pose a risk to operator safety. By preventing the transfer of electrical energy from the external power source 136 to the internal energy storage system 150 when the door 104 is in the open position 116, the system 100 protects the lift device 10 against electrical arcing. Protecting the lift device 10 against electrical arcing prolongs the life of the lift device 10 and the system 100. Other charging systems require the use of a 2-stage charging system that requires a shutdown of electrical energy transfer before opening a door and disconnecting the two power connectors. Further, other charging systems require current snubbing (e.g., providing a path for transient current flow). Further, other charging systems have a limited selection of solutions for disconnecting the two power connectors and are more expensive to install, maintain, and service. Limitations of other charging systems requiring a 2-stage operation diminish the performance of the charging operations. The system 100 of the present disclosure maintains the lift device 10 and other machines charged and fully functional by providing operators and service personnel a fast and convenient method to charge the lift device 10. Further, the system 100 facilitates minimizing downtime and repairs that would otherwise arise from electrical arcing.

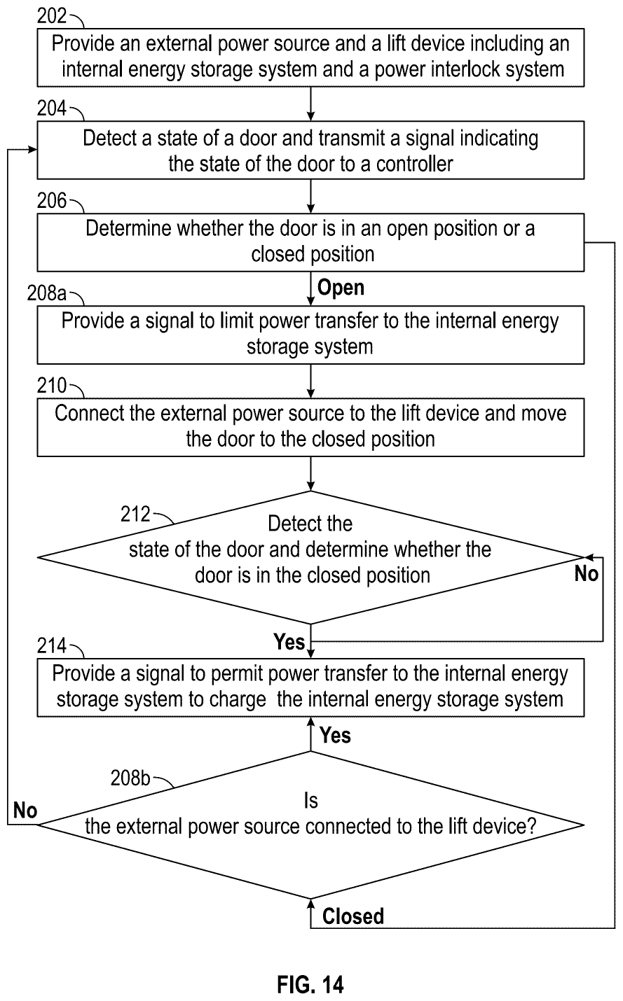

Referring to FIG. 14, a flow diagram of a process 200 for charging or otherwise providing electrical energy from an external power source to a lift device (e.g., lift device 10) includes steps 202-212, according to some embodiments. The process 200 or portions thereof may be performed by the controller 38 according to feedback from the sensor 112 (e.g., the signal from the sensor 112) to determine the state of the door 104 and automatically prevent or permit the transfer of electrical energy from the external power source 136 to the internal energy storage system 150.

At step 202, a lift device including an internal energy storage system (e.g., internal energy storage system 150) and a power connector interlock system (e.g., system 100) is provided and an external power source (e.g., external power source 136) is provided, according to some embodiments. At step 204, a sensor (e.g., sensor 112) detects a state (e.g., position, location, proximity, etc.) of a door (e.g., door 104) and transmits a signal that may be associated with or include an indication of the state of the door to a controller (e.g., controller 38). At step 206, the controller determines whether the door is in an open position (e.g., open position 116) or a closed position (e.g., closed position 120). Responsive to a determination that the door is in the open position, at step 208a, the controller provides a signal to the external power source commanding the external power source to prevent power transfer to the internal energy storage system. Responsive to a determination that the door is in the closed position, at step 208b, a determination is made of whether the external power source is connected to the lift device. At step 208b, if a determination is made that the external power source is connected to the lift device, steps 210 and 212 are skipped and the process 200 continues to step 214. At step 208b, if a determination is made that that the door is in the closed position and the external power source is not connected to the lift device, the process 200 returns to step 204. At step 210, an operator connects the external power source to the lift device and moves the door to the closed position. At step 212, the sensor detects the state of the door and transmits the signal to the controller that determines whether the door is in the closed position. Responsive to a determination that the door is not in the closed position, step 212 is repeated. Responsive to a determination that the door is in the closed position, at step 214, the controller provides a signal to the external power source commanding the external power source to permit power transfer to the internal energy storage system to charge the internal energy storage system. After step 214, the process 200 may return to step 204.

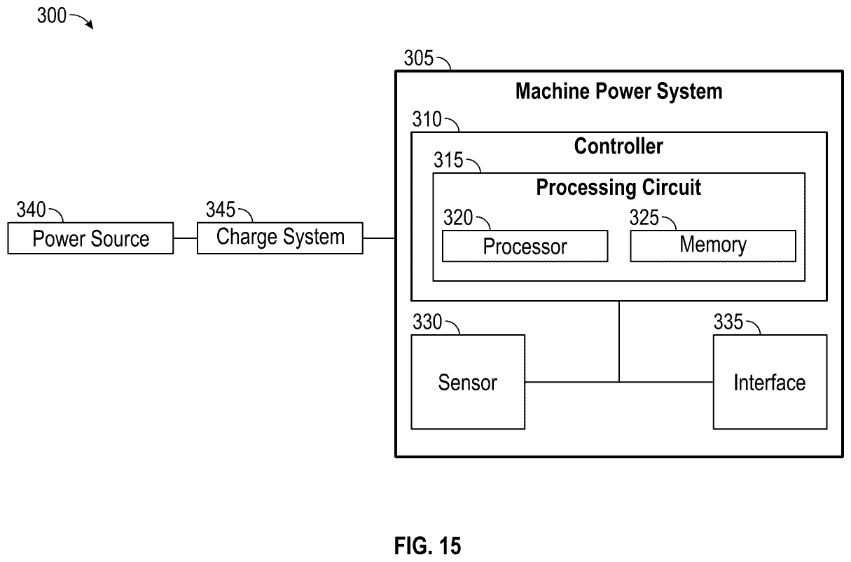

FIG. 15 depicts a block diagram of a system 300 to control charging of a battery, according to some embodiments. In some embodiments, the system 300 may control charging of the batteries 64. Each system, device, and/or component of the system 300 may include one or more processors, memory, network interfaces, communication interfaces, and/or user interfaces. In some embodiments, the memory may store programming logic that, when executed by the processors, controls the operation of the corresponding system, device, and/or component. Memory can store data in databases. The network interfaces may allow the systems and/or components of the system 300 to communication with one another wirelessly.

The communication interfaces may include wired and/or wireless communication interfaces and the systems and/or components of the system 300 may be connected via the communication interfaces. The various components of the system 300 may include implementations via hardware (e.g., circuitry), software (e.g., executable code), or any combination thereof. Systems, devices, and/or components of the system 300 may be added, removed, modified, separated, combined, rearranged, deleted, integrated, and/or adjusted. For example, a first device that is shown to include a first component and a second component may be modified so that the first component and the second component are provided as a single component. As another example, a device that is shown to be included within a first system may also be added to a second system.

In some embodiments, the system 300 may include at least one machine power system 305, at least one power source 340, and at least one charge system 345. In some embodiments, the system 300 and/or one or more systems, devices, and/or components thereof may include at least one of the various systems, devices, and/or components described herein. For example, the machine power system 305 may include the controller 38. As another example, the system 300 may include one or more systems, devices, and/or components of the system 100. In some embodiments, the system 300 and/or one or more systems, devices, and/or components thereof may perform similar operations to at least one of the systems, devices, and/or components described herein. For example, the machine power system 305 may facilitate charging of the batteries 64.

In some embodiments, the system 300 and/or one or more systems, devices, and/or components may be included in at least one of the various machines and/or vehicles described herein. For example, the machine power system 305 may be included in the lift device 10. In some embodiments, the system 300 and/or one or more systems, devices, and/or components thereof may be remote and/or external to at least one of the various machines and/or vehicles described herein. For example, the machine power system 305 may be distributed across one or more servers and the machine power system 305 may communicate and/or interface with the lift device 10 via a network. In some embodiments, the lift device 10 may include a computing system and/or one or more processing circuits (e.g., the controller 38) that may implement and/or perform operations similar to that of the machine power system 305.

In some embodiments, systems, devices, and/or components of the system 300 may communicate with one another via one or more networks. For example, the charge system 345 and the machine power system 305 may communicate with one another via at least one of wired and/or wireless telecommunications. As another example, the charge system 345 and the machine power system 305 may communicate with one another via at least of Wide-Area Networks (WANs), Local Area Networks (LANs), and/or a Controller Area Network (CAN). In some embodiments, the systems, devices, and/or components of the system 300 may communicate via at least one of the various types of communication described herein.

In some embodiments, the charge system 345 may include at least one of the various connectors, connections, and/or cables described herein. For example, the charge system 345 may include the first power connector 108. In some embodiments, the charge system 345 may be in communication with the power source 340. For example, the charge system 345 may be electrically coupled with the power source 340. In some embodiments, the charge system 345 may control, adjust, and/or otherwise modify an amount of power that is provided by the power source 340. For example, the charge system 345 may include a battery module and/or a power module to control an amount of voltage and/or current that is provided by the power source 340. In some embodiments, the charge system 345 may communicate with the machine power system 305 to determine given amounts of power, voltage, and/or current to provide, from the power source 340, to lift device 10 to charge the batteries 64. For example, the first power connector 108 and the second power connector 132 may establish communication between the charge system 345 and the machine power system 305. In some embodiments, the charge system 345 may electrically couple, via the first power connector 108, the machine power system 305 with the power source 340.

In some embodiments, the machine power system 305 may include at least one controller 310, at least one sensor 330, and at least one interface 335. In some embodiments, the controller 310 may perform operations similar to at least one of the various controllers, computing systems, and/or processing circuits described herein. For example, the controller 310 may perform operations similar to that of the controller 38. In some embodiments, the sensors 330 may include at least one of the various sensors and/or sensor types described herein. For example, the sensors 330 may include the sensors 112. In some embodiments, the sensors 330 may detect, collect, and/or otherwise obtain at least one of the various types of measurements, statuses, and/or vehicle information described herein. For example, the sensors 330 may detect a State of Charge (SoC) of the batteries 64. As another example, the sensors 330 may detect that the door 104 has been opened and/or closed.

In some embodiments, the interface 335 may include at least one of network communication devices, network interfaces, and/or other possible communication interfaces. The interface 335 may include wired or wireless communications interfaces (e.g., jacks, antennas, transmitters, receivers, transceivers, wire terminals, etc.) for conducting data communications with various systems, devices, and/or components described herein. In some embodiments, the interface 335 may include direct (e.g., local wired or wireless communications) and/or via a communications network. For example, the interface 335 includes an Ethernet card and port for sending and receiving data via an Ethernet-based communications link or network. In some embodiments, the interface 335 may include a Wi-Fi transceiver for communicating via a wireless communications network. In some embodiments, the interface 335 includes a power line communications interface. In some embodiments, the interface 335 may include an Ethernet interface, a Universal Serial Bus (USB) interface, a serial communications interface, and/or a parallel communications interface. In some embodiments, the interface 335 connects and/or integrates the machine power system 305 with the charge system 345.

In some embodiments, the interface 335 may include one or more systems, devices, and/or components of the system 100. For example, the interface 335 may include the second power connector 132. As another example, the interface 335 may be integrated with and/or included in one or more systems, devices, and/or components of the system 100. In some embodiments, the interface 335 may establish communication between the machine power system 305 and the charge system 345. For example, the controller 310 may provide, via the interface 335, one or more signals to the charge system 345. As another example, the charge system 345 may include the first power connector 108 and the interface 335 may include the second power connector 132.

In some embodiments, the controller 310 may include at least one processing circuit 315. The processing circuit 315 may refer to and/or include at least one of the various processing circuits, circuits, and/or circuitry described herein. In some embodiments, the processing circuit 315 includes at least one processor 320 and memory 325. Memory 325 may include includes one or more devices (e.g., Random Access Memory (RAM), Read Only Memory (ROM), Flash memory, hard disk storage) for storing data and/or computer code for completing and/or facilitating the various processes described herein. Memory 325 may include non-transient volatile memory, non-volatile memory, and non-transitory computer storage media. Memory 325 may include database components, object code components, script components, or any other type of information structure for supporting the various activities and information structures described herein. Memory 325 may be communicably coupled to the processors 320 and memory 325 may include computer code or instructions (e.g., firmware or software) for executing one or more processes described herein.

In some embodiments, the processors 320 may be implemented as at least one of one or more application specific integrated circuits (ASICs), field programmable gate arrays (FPGAs), a group of processing components, or other suitable electronic processing components. In some embodiments, memory 325 may store one or more instructions that, when executed by the processors 320, cause the processors 320 to perform one or more of the various operations described herein. In some embodiments, memory 325 may store, keep, and/or maintain at least one of records, tables, databases, data structures, and/or collections of information.

In some embodiments, the processing circuit 315 may determine that a machine is electrically coupled with a power source. For example, the processing circuit 315 may determine that the lift device 10 is electrically coupled with the power source 340. In some embodiments, the processing circuit 315 may determine that the lift device 10 is electrically coupled with the power source 340 responsive to detecting that the first power connector 108 and the second power connector 132 (e.g., the interface 335) have been coupled with one another. For example, the lift device 10 and the power source 340 may be electrically coupled with one another via the first power connector 108 and the second power connector 132, and the processing circuit 315 may detect the electrical coupling between the lift device 10 and the power source 340 responsive to detecting the first power connector 108.

In some embodiments, the processing circuit 315 may receive one or more signals. For example, the processing circuit 315 may receive one or more signals from the charge system 345. In some embodiments, the processing circuit 315 may receive, via the interface 335, the signals from the charge system 345. For example, the charge system 345 may provide one or more signals to the interface 335 and the interface 335 may provide the signals to the processing circuit 315. In some embodiments, the processing circuit 315 may receive signals to initiate charging of a battery. For example, the processing circuit 315 may receive signals to initiate charging of the batteries 64. In some embodiments, the processing circuit 315 may receive a signal to indicate that the charge system 345 and the machine power system 305 have established communication with one another.

In some embodiments, the processing circuit 315 may transmit one or more signals. For example, the processing circuit 315 may transmit a first signal and a second signal to the charge system 345. In some embodiments, the processing circuit 315 may transmit signals having one or more parameters. For example, the processing circuit 315 may transmit signals to indicate an amount of voltage and/or an amount of current to receive from the power source 340. In some embodiments, the processing circuit 315 may transmit signals to define an amount of power that is received from the power source 340. For example, the processing circuit 315 may transmit, via the interface 335, one or more signals including parameters to indicate an amount of voltage and an amount of current to define an amount of power.

In some embodiments, the processing circuit 315 may electrically couple the batteries 64 with the power source 340. For example, the processing circuit 315 may open and/or close one or more switches (e.g., relays 152 and 156) to connect the batteries 64 with the power source 340. In some embodiments, the processing circuit 315 may electrically couple the batteries 64 with the power source 340 to charge the batteries 64.

In some embodiments, the processing circuit 315 may detect that one or more components have moved and/or charged positions. For example, the processing circuit 315 may detect that the door 104 has moved from an open position (e.g., a first position) to a closed position (e.g., a second position). In some embodiments, the processing circuit 315 may detect that the door 104 has moved to the closed position based on one or more signals provided by the sensors 330.

In some embodiments, the processing circuit 315 may transmit one or more subsequent signals. For example, the processing circuit 315 may continuously and/or semi-continuously transmit signals to the charge system 345 to adjust, control, and/or modify an amount of power that is provided to the batteries 64. For example, the processing circuit 315 may determine that the door 104 is open and when the door 104 is open the processing circuit 315 may transmits signals, to the charge system 345, to receive a first amount of power from the power source 340. As another example, the processing circuit 315 may determine that the door 104 is closed and the processing circuit 315 may transmits signals, to the charge system 345, to receive a second amount of power from the power source 340.

In some embodiments, the processing circuit 315 may identify one or more aspects of the lift device 10 to determine parameters to define an amount of power. For example, the processing circuit 315 may determine an SoC of the batteries 64 and the processing circuit 315 may use the SoC of the batteries 64 to determine an amount of power to use in charging the batteries. In some embodiments, the batteries 64 may include one or more SoC ranges and the processing circuit 315 may use a given SoC range to determine parameters to define one or more amounts of power. In some embodiments, the processing circuit 315 may determine one or more additional and/or subsequent aspects of the batteries 64. For example, the sensor 330 may collect temperature information associated with the batteries 64 and the processing circuit 315 may use the temperature information to determine a temperature of the batteries 64. As another example, the batteries 64 may include multiple batteries and the processing circuit 315 may determine, based on a number of batteries included in the batteries 64, one or more amounts of power to use when charging the batteries 64.

In some embodiments, the position and/or placement of the door 104 may dictate and/or define one or more amounts of power. For example, the processing circuit 315 may provide a first amount of power to the batteries 64 when the door 104 is in an open position. As another, the processing circuit 315 may provide a second amount of power when the door 104 is a closed position. In some embodiments, the amount of power provided to the batteries 64 may include characteristics associated with and/or corresponding to fast charging. For example, the amount of power provided to the batteries 64 may include an amperage (e.g., current) amount of 200 amps. As another example, the amount of power provided to the batteries 64 may include a voltage amount of 200 volts.

In some embodiments, the position and/or placement of the door 104 may define and/or dictate when the batteries 64 are charged using amounts of powers that correspond to fast charging. For example, when the door 104 is in a closed position, the processing circuit 315 may communicate with the charge system 345 to receive, from the power source 340, an amount of power that corresponds to fast charging. As another example, when the door 104 is in an open position, the processing circuit 315 may communicate with the charge system 345 to receive, from the power source 340, an amount of power that corresponds to low voltage charging.

In some embodiments, the processing circuit 315 may monitor the batteries 64. For example, the processing circuit 315 may monitor the batteries to detect a change in a SoC to the batteries 64. As another example, the processing circuit 315 may monitor the batteries 64 to detect a change from a first status to a second status. To continue this example, the first status may refer to and/or include a first SoC and the second status may include a second SoC. In some embodiments, the processing circuit 315 may use information provided by the sensors 330 to monitor the batteries 64.

In some embodiments, the processing circuits 315 may provide one or more signals responsive to monitoring the batteries. For example, the processing circuits 315 may detect that the batteries 64 have reached a SoC of a given amount. To continue this example, the processing circuit 315 may transmit, via the interface 335, one or more signals to the charge system 345 to adjust an amount of power provided to the batteries 64. In some embodiments, the processing circuit 315 may detect one or more amounts of power. For example, the processing circuit 315 may detect amounts of power provided by the power source 340. In some embodiments, the processing circuit 315 may electrically decouple the power source 340 from the batteries 64. For example, the processing circuit 315 may transmits a signal to define an amount of power having zero amps and the processing circuit 315 may electrically decouple the batteries 64 from the power source 340 responsive to detecting an amount of power having zero amps.

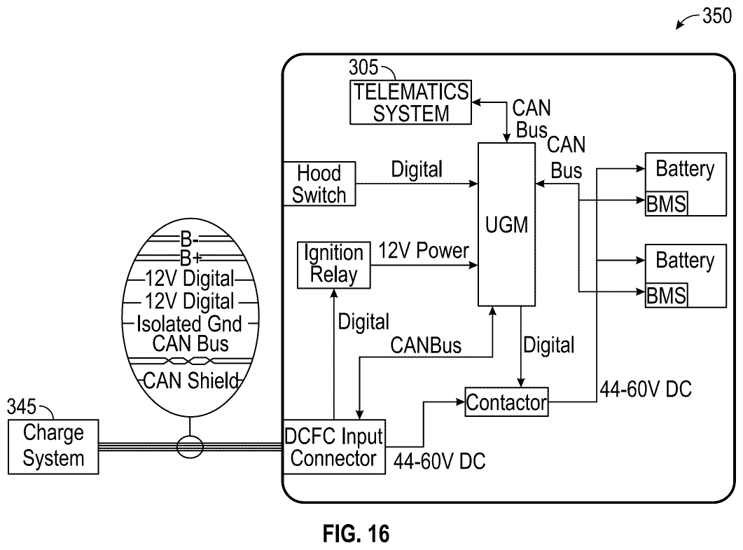

FIG. 16 depicts a block diagram including a schematic block diagram 350 of one or more components of the machine power system 305, according to some embodiments. As shown in FIG. 16, the machine power system 305 includes a hood switch, an ignition relay, a DCFC input connector, a contactor, one or more batteries, and a UGM (e.g., a controller). In some embodiments, the DCFC connector may refer to and/or include the interface 335 and/or the second connector 132. In some embodiments, the contactor may include at least one of the switches 152 and 156. In some embodiments, the UGM may refer to and/or include the controller 310. In some embodiments, the hood switch may provide one or more signals to indicate an opening and/or closing of a hood of the lift device 10. In some embodiments, the ignition relay may provide one or more signals to indicate an activation and/or deactivation of an ignition of the lift device 10.

FIG. 16 depicts an example of one or more signals that may be communicated between the machine power system 305 and the charge system 345. In some embodiments, the signals illustrated in FIG. 16 may be communicated via the first power connector 108 and/or the second power connector 132. As shown in FIG. 16, the signals may include a positive power signal (e.g., B+) and a negative power signal (B−). The B+ signal and the B− signal may refer to the various amounts of power described herein. The signals communicated between the machine power system 305 and the charge system 345 may include CANBUS signals, digital signals, and a ground signal. In some embodiments, the various types of parameters described herein may be provided by the CANBUS.

As shown in FIG. 16, the batteries includes one or more Battery Management Systems (BMSs). In some embodiments, the BMSs may provide one or more signals to the processing circuit 315. For example, the BMSs may provide one or more signals to indicate a status of the batteries 64. In some embodiments, the processing circuit 315 may determine one or more parameters based on the signals provided by the BMSs. For example, the processing circuit 315 may determine an amount of voltage (e.g., a parameter) to use when charging the batteries 64 based on the signals provided by the BMSs.

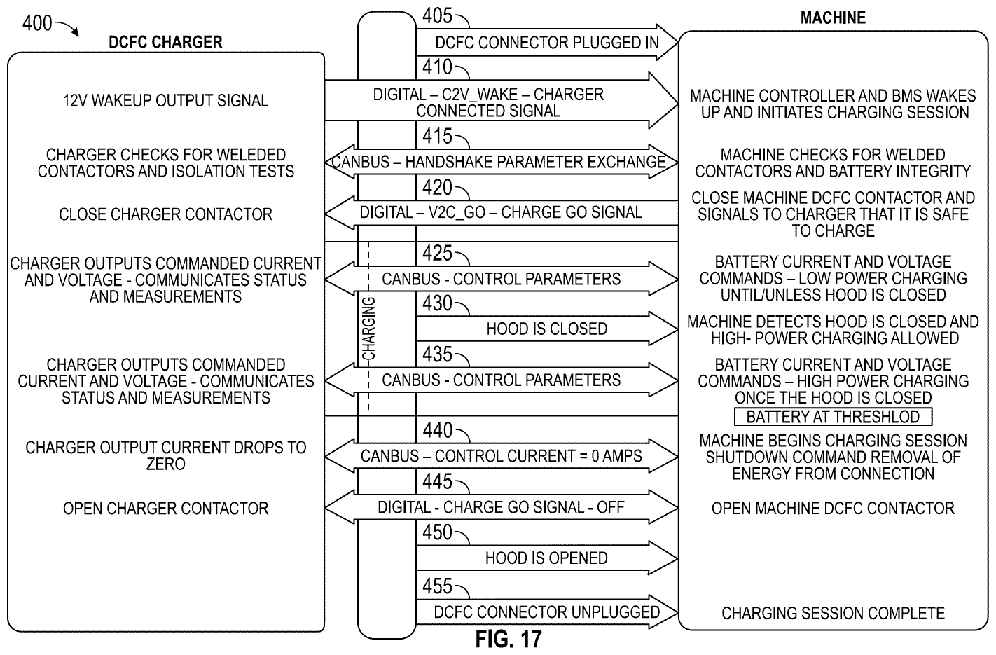

FIG. 17 depicts a sequence diagram of a process 400 to control charging of a battery for a machine, according to some embodiments. In some embodiments, one or more steps of the process 400 may be implemented to control charging of the batteries 64. At least one of the various systems, devices, and/or components described herein may perform at least one step of the process 400. For example, the processing circuit 315 may perform at least one step of the process 400. As another example, the charge system 345 may perform at least one step of the process 400. In some embodiments, at least one of the various computing systems, circuits, circuitry, and/or processing circuits described herein may be coupled with memory storing executable code that cause a corresponding system to perform at least one step of the process 400. For example, the controller 38 may include executable code to cause the controller 38 to perform at least one step of the process 400. In some embodiments, the steps of the process 400 may occur concurrently, sequentially, consecutively, simultaneously, in order, continuously, and/or semi-continuously. For example, a first step and a second step of the process 400 may occur at the same time. As another example, a first step of the process 400 may be followed by a second step of the process 400.

In some embodiments, step 405 may include determining that a connector is plugged in. For example, the processing circuit 315 may determine that the first power connector 108 is plugged into the second power connector 132. As another example, the processing circuit 315 may determine that the machine power system 305 is connected with the charge system 345. In some embodiments, the processing circuit 315 may determine that the DCFC connector is plugged in. For example, the processing circuit 315 may determine that the DCFC connector is plugged into to the charge system 345.

In some embodiments, step 410 may include transmitting one or more Charge to Vehicle (C2V) signals. For example, the charge system 345 may transmit the C2V signal to the machine power system 305. In some embodiments, the C2V signal may include parameters to indicate that the lift device 10 is electrically coupled with the power source 340. For example, the C2V signal may indicate that the charge system 345 detected a connection between the lift device 10 and the charge system 345. As another example, the C2V signal may include a voltage level that activates (e.g., wakes up) one or more components of the machine power system 305.

In some embodiments, step 415 may include transmitting one or more parameters. For example, the interface 335 may provide, via one or more signals, connection parameters to the charge system 345. In some embodiments, the connection parameters may indicate that the prongs and/or ports of the second power connector 132 are connected with the prongs and/or ports of the first power connector 108. The interface 335 may transmit the connection parameters responsive to the machine power system 305 evaluating the connection between the lift device 10 and the charge system 345. For example, the machine power system 305 may conduct a test on the connection to check for any welded contactors. In some embodiments, the charge system 345 may perform similar tests on the connection between charge system 345 and the lift device 10. Stated otherwise, the machine power system 305 may check the connection between the second power connector 132 and the first power connector 108.

In some embodiments, step 420 may include transmitting one or more Vehicle to Charger (V2C) signals. For example, the interface 335 may provide V2C signals to the charge system 345. In some embodiments, the V2C signals may initiate and/or indicate that the lift device 10 is ready for a charging sequence. For example, the V2C signals may indicate that the machine power system 305 has closed contactors between the second power connector 132 and the internal energy storage system 150 (e.g., the batteries 64 are ready to be electrically coupled with the power source 340).

In some embodiments, step 425 may include transmitting one or more parameters. For example, the interface 335 may transmit one or more charging parameters to the charge system 345. In some embodiments, the charging parameters may indicate at least one of a voltage level, a current level, and/or an amount of power. For example, the charging parameters may request, from the power source 340, 10 Watts (e.g., an amount of power). In some embodiments, the machine power system 305 may generate the charging parameters based on a status and/or a condition of the door 104. For example, when the door 104 is open, the machine power system 305 may generate a first set of charging parameters. As another example, when the door 104 is closed, the machine power system 305 may generate a second set of charging parameters.

In some embodiments, the charge system 345 may provide, from the power source 340, an amount of power based on the charging parameters provided by the interface 335. For example, the charge system 345 may control the power source 340 to provide 100 watts of power responsive to the machine power system 305 asking for 100 watts. In some embodiments, the machine power system 305 and the charge system 345 may communicate and/or transmit the charging parameters via a CAN bus.

In some embodiments, the interface 335 transmitting the charging parameters may initiate a charging session for the lift device 10. For example, the batteries 64 may receive, from the power source 340, electrical power responsive to the transmission of the charging parameters. In some embodiments, the machine power system 305 and the charge system 345 may continuously and/or semi-continuously transmit charging parameters during a charging session. For example, the charge system 345 may provide charging parameters that indicate and/or identify an amount of power that is being provided to the batteries 64. As another example, the machine power system 305 may provide charging parameters that indicate a temperature of the batteries 64.

In some embodiments, step 430 may include detecting a change in the position of the door 104. For example, the machine power system 305 may detect that the door 104 moved to a closed position. In some embodiments, the door 104 moving to the closed position may indicate that the connection between the first power connector 108 and the second power connector 132 is isolated and/or confined within a housing of the lift device 10. In some embodiments, the machine power system 305 may determine, responsive to detecting that the door 104 is closed, that a fast-charging session may be initiated. For example, the machine power system 305 may determine that the batteries 64 can receive one or more amounts of power indicative of fast charging.

In some embodiments, step 435 may include transmitting one or more parameters. For example, the interface 335 may transmit one or more second charging parameters to the charge system 345. In some embodiments, the one or more second charging parameters may indicate and/or identify a charge to an amount of power to provide to the batteries 64. For example, the second charging parameters may request an amount of power that is greater than and/or larger than an amount of power currently being provided to the batteries 64. Stated otherwise, the second charging parameters may indicate a request for an increase to the amount of power being provided to the batteries 64. In some embodiments, the second charging parameters may indicate and/or identify one or more amounts of power indicative of fast charging. For example, the second charging parameters may indicate a request to receive 400 watts of power.

In some embodiments, the machine power system 305 may monitor and/or evaluate the status of the batteries 64. For example, the sensors 330 may collect information to indicate an SoC and/or a charge level of the batteries 64. To continue this example, the machine power system 305 may determine, based on the information collected by the sensors 330, a charge status and/or a level of charge for the batteries 64. In some embodiments, the charging of the batteries 64, based on the second charging parameters, may continue for a given amount of time and/or until a given battery charge level is reached. For example, the batteries 64 may receive amounts of power indicative of fast charging until the batteries 64 reach a 75% charge level. As another example, the batteries 64 may receive amounts of power indicative of fast charging for 40 minutes.

In some embodiments, the machine power system 305 may detect and/or determine that the batteries 64 reached one or more thresholds. For example, the machine power system 305 may detect that the batteries 64 reached a given charge level.

In some embodiments, step 440 may include transmitting one or more parameters. For example, the interface 335 may transmit one or more third charging parameters to indicate that the batteries 64 reached a given threshold. In some embodiments, the one or more third charging parameters may identify and/or indicate one or more amounts of power. For example, the one or more third charging parameters may indicate a request to receive zero amps (e.g., no and/or minimal amounts of current) from the power source 340. In some embodiments, the interface 335 transmitting the one or more third charging parameters may indicate and/or initiate a shutdown sequent to complete charging of the batteries 64. In some embodiments, the charge system 345 may provide one or more parameters to indicate that the power source 340 is provided the amount of power indicated by the one or more third charging parameters. For example, the charge system 345 may provide one or more parameters that indicate that the power source 340 is providing zero amps.

In some embodiments, step 445 may include transmitting one or more signals to indicate completion of a charging session. For example, the interface 335 may transmit one or more signals to the charge system 345 to indicate that the connectors between the second power connector 132 and the internal energy storage system 150 have been opened.

In some embodiments, step 450 may include detecting that the door is in an open position. For example, the machine power system 305 may detect that the door 104 is in an open position.

In some embodiments, step 455 may include determining that the first power connector 108 and the second power connector 132 have been decoupled from one another. For example, the machine power system 305 may detect that the first power connector 108 has been unplugged from the second power connector 132. As another example, the machine power system 305 may detect that the second power connector 132 is no longer connected with the first power connector 108.

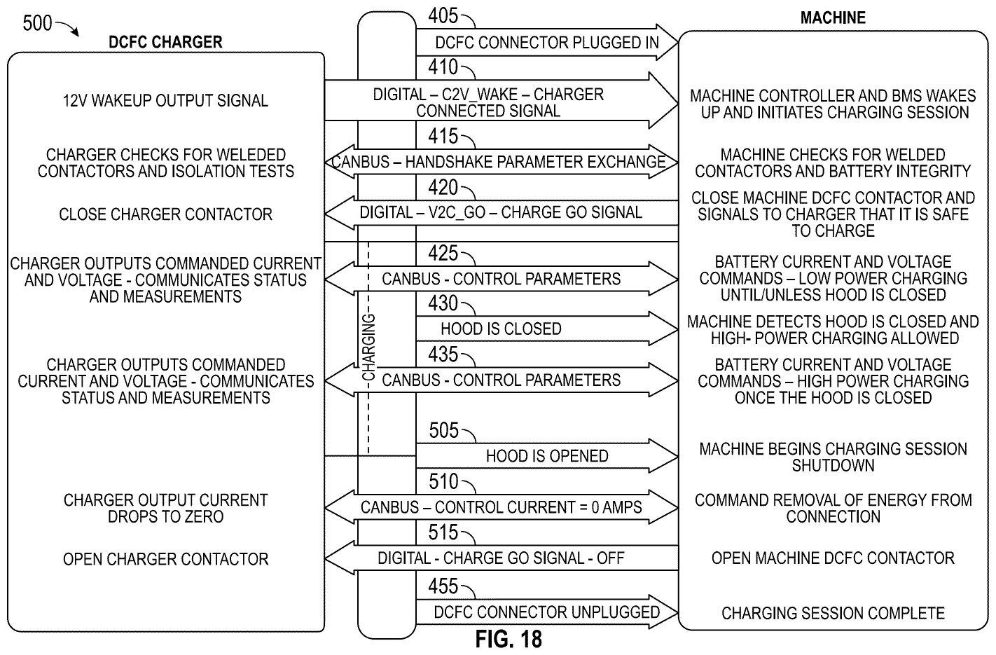

FIG. 18 depicts a sequence diagram of a process 500 to control charging of a battery for a machine, according to some embodiments. In some embodiments, one or more steps of the process 500 may be implemented to control charging of the batteries 64. At least one of the various systems, devices, and/or components described herein may perform at least one step of the process 500. For example, the processing circuit 315 may perform at least one step of the process 500. As another example, the charge system 345 may perform at least one step of the process 500. In some embodiments, at least one of the various computing systems, circuits, circuitry, and/or processing circuits described herein may be coupled with memory storing executable code that cause a corresponding system to perform at least one step of the process 500. For example, the controller 38 may include executable code to cause the controller 38 to perform at least one step of the process 500. In some embodiments, the steps of the process 500 may occur concurrently, sequentially, consecutively, simultaneously, in order, continuously, and/or semi-continuously. For example, a first step and a second step of the process 500 may occur at the same time. As another example, a first step of the process 400 may be followed by a second step of the process 500.

In some embodiments, the process 500 may include one or more steps similar to and/or described above with respect to the process 400. For example, the process 500 may include steps 405-435. In some embodiments, the process 500 may include more steps and/or less steps than the number of steps illustrated in FIG. 18.

In some embodiments, the process 500 may include initiating and/or establishing a charging session between the lift device 10 and the power source 340. For example, the machine power system 305 may transmit one or more signals to initiate a charging session between the batteries 64 and the power source 340. In some embodiments, the machine power system 305 may determine a position of the door 104. For example, the machine power system 305 may determine that the door 104 is closed.

In some embodiments, step 505 may include determining that the door (i.e., hood) has opened. For example, the machine power system 305 may determine that door 104 is in an open position. In some embodiments, the door 104 being in the open position may indicate that a user may attempt to decouple the lift device 10 from the power source 340. For example, the user may attempt to disconnect the first power connector 108 from the second power connector 132. In some embodiments, the machine power system 305 may initiate the shutdown sequent described herein responsive to detecting that the door 104 is in the open position.

In some embodiments, step 510 may include transmitting one or more parameters. For example, the interface 335 may transmit one or more parameters to the charge system 345. In some embodiments, the one or more parameters may indicate that the door 104 is in the open position. The one or more parameters may also indicate and/or identify an amount of power. For example, the one or more parameters may indicate a request for zero amps from the power source 340. In some embodiments, step 510 may include transmitting signals and/or parameters similar to that described in step 440.

In some embodiments, step 515 may include transmitting one or more signals to indicate decoupling between the lift device 10 and the power source 340. For example, the interface 335 may provide one or more signals to indicate that the power source 340 is no longer electrically coupled with the batteries 64. In some embodiments, the charge system 345 may open one or more connectors to electrically decouple the power source 340 with the first power connector 108. For example, the charge system 345 may open one or more switches to isolate the power source 340 from the first power connector 108. In some embodiments, step 515 may include transmitting one or more signals and/or parameters similar that in step 445.

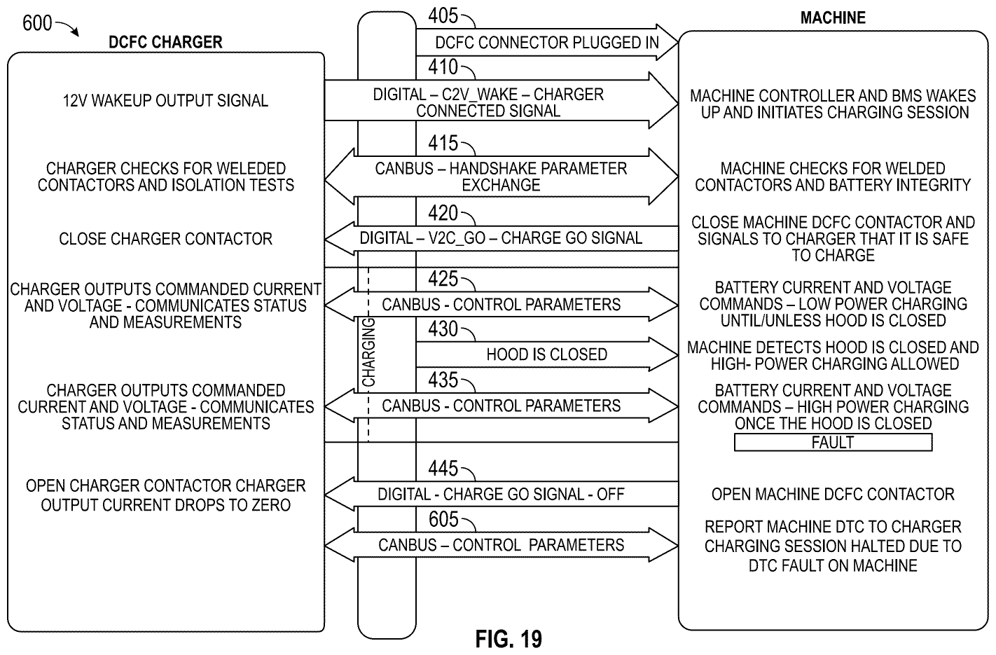

FIG. 19 depicts a sequence diagram of a process to control charging of a battery for a machine, according to some embodiments. In some embodiments, one or more steps of the process 600 may be implemented to control charging of the batteries 64. At least one of the various systems, devices, and/or components described herein may perform at least one step of the process 600. For example, the processing circuit 315 may perform at least one step of the process 600. As another example, the charge system 345 may perform at least one step of the process 600. In some embodiments, at least one of the various computing systems, circuits, circuitry, and/or processing circuits described herein may be coupled with memory storing executable code that cause a corresponding system to perform at least one step of the process 600. For example, the controller 38 may include executable code to cause the controller 38 to perform at least one step of the process 600. In some embodiments, the steps of the process 600 may occur concurrently, sequentially, consecutively, simultaneously, in order, continuously, and/or semi-continuously. For example, a first step and a second step of the process 600 may occur at the same time. As another example, a first step of the process 600 may be followed by a second step of the process 600.

In some embodiments, the process 600 may include one or more steps similar to and/or described above with respect to at least one of the process 400 and/or the process 500. For example, the process 600 may include steps 405-435. In some embodiments, the process 600 may include more steps and/or less steps than the number of steps illustrated in FIG. 19.

In some embodiments, the process 600 may include initiating and/or establishing a charging session between the lift device 10 and the power source 340. For example, the machine power system 305 may transmit one or more signals to initiate a charging session between the batteries 64 and the power source 340. In some embodiments, the machine power system 305 may determine a position of the door 104. For example, the machine power system 305 may determine that the door 104 is closed.

In some embodiments, the machine power system 305 may detect one or more faults. For example, the machine power system 305 may receive one or more signals from a BMS for the batteries 64. To continue this example, the machine power system 305 may detect, based on the signals provided by the BMS, one or more faults associated with the batteries 64. In some embodiments, the faults may include at least one of a battery temperature exceeding a predetermined threshold and/or level, a loss in communication between one or more components of the machine power system 305, a loss in communication between one or more components of the lift device 10, one or more Diagnostic Trouble Codes (DTC), and/or other possible faults.

In some embodiments, step 605 may include transmitting one or more signals. For example, the interface 335 may transmit one or more signals to the charge system 345. In some embodiments, the interface 335 may transmit signals to indicate and/or identify the fault detected by the machine power system 305. For example, the interface 335 may transmit signals to indicate a fault in communication between the machine power system 305 and the relays 152 and 156. In some embodiments, the interface 335 transmitting the signals may halt and/or pause the charging session between the batteries 64 and the power source 340.

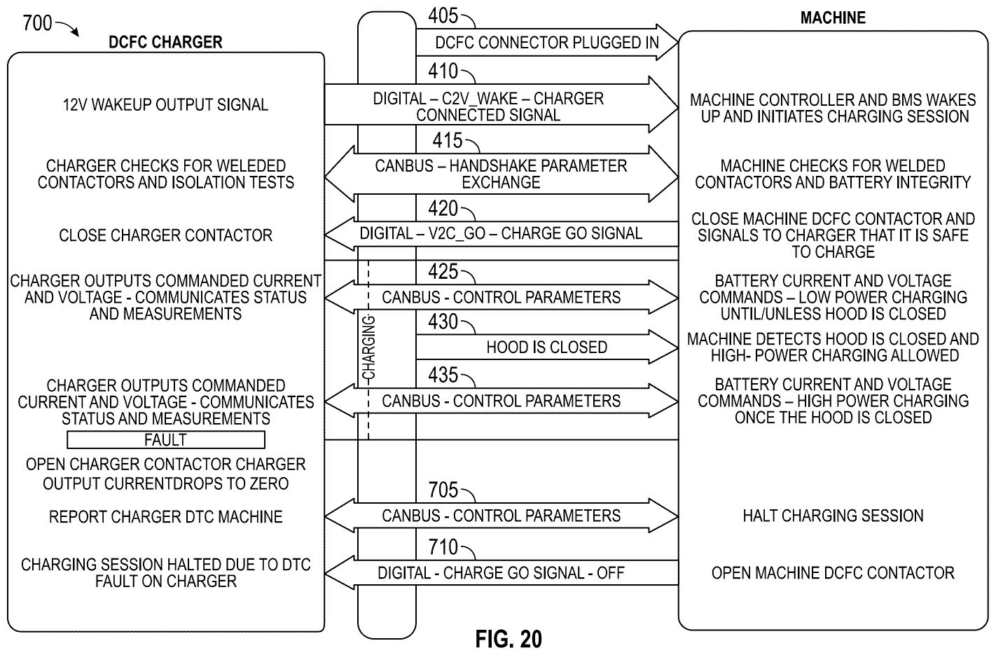

FIG. 20 depicts a sequence diagram of a process 700 to control charging of a battery for a machine, according to some embodiments. In some embodiments, one or more steps of the process 700 may be implemented to control charging of the batteries 64. At least one of the various systems, devices, and/or components described herein may perform at least one step of the process 700. For example, the processing circuit 315 may perform at least one step of the process 700. As another example, the charge system 345 may perform at least one step of the process 700. In some embodiments, at least one of the various computing systems, circuits, circuitry, and/or processing circuits described herein may be coupled with memory storing executable code that cause a corresponding system to perform at least one step of the process 700. For example, the controller 38 may include executable code to cause the controller 38 to perform at least one step of the process 700. In some embodiments, the steps of the process 700 may occur concurrently, sequentially, consecutively, simultaneously, in order, continuously, and/or semi-continuously. For example, a first step and a second step of the process 700 may occur at the same time. As another example, a first step of the process 700 may be followed by a second step of the process 700.

In some embodiments, the process 700 may include one or more steps similar to and/or described above with respect to at least one of the process 400, the process 500, and/or the process 600. For example, the process 700 may include steps 405-435. In some embodiments, the process 700 may include more steps and/or less steps than the number of steps illustrated in FIG. 20.

In some embodiments, the process 700 may include initiating and/or establishing a charging session between the lift device 10 and the power source 340. For example, the machine power system 305 may transmit one or more signals to initiate a charging session between the batteries 64 and the power source 340. In some embodiments, the machine power system 305 may determine a position of the door 104. For example, the machine power system 305 may determine that the door 104 is closed.

In some embodiments, the charge system 345 may monitor and/or observe performance of the power source 340. For example, the charge system 345 may compare a requested amount of power with an amount of power provided by the power source 340. Stated otherwise, the charge system 345 may provide a request for the power source 340 to provide X amount of power and the charge system 345 may compare the X amount of power with Y amount of power that is provided by the power source 340. In some embodiments, the charge system 345 may detect one or more faults. For example, the charge system 345 may detect that the power source 340 is providing an amount of power that is different than a requested amount of power. As another example, the charge system 345 may detect a loss in a connection with the power source 340.

In some embodiments, step 705 may include transmitting one or more parameters. For example, the charge system 345 may transmit, via one or more signals, parameters that indicate and/or identify the fault detected by the charge system 345. In some embodiments, the charge system 345 may isolate the power source 340 from the lift device 10. For example, the charge system 345 may open one or more switches and/or connectors. In some embodiments, the charge system 345 may isolate the power source 340 responsive to detecting one or more faults. In some embodiments, the charge system 345 may transmit parameters to indicate that the power source 340 has been isolated.

In some embodiments, the machine power system 305 may halt and/or pause a charging system responsive to receiving the parameters from the charge system 345. For example, the machine power system 305 may provide signals having parameters to request zero amps. As another example, the interface 335 may provide signals having parameters to indicate a request for zero power.

In some embodiments, step 710 may include transmitting one or more signals. For example, the interface 335 may transmit, to the charge system 345, one or more signals to indicate a halt and/or a pause to a charging session. In some embodiments, the machine power system 305 may pause and/or halt the charging session by isolating the internal energy storage system 150 from the second power connector 132. In some embodiments, the interface 335 may transmit one or more parameters, to charge system 345, to indicate that the machine power system 305 isolated (e.g., opened relays 152 and 156) the internal energy storage system 150 from the second power connector 132.

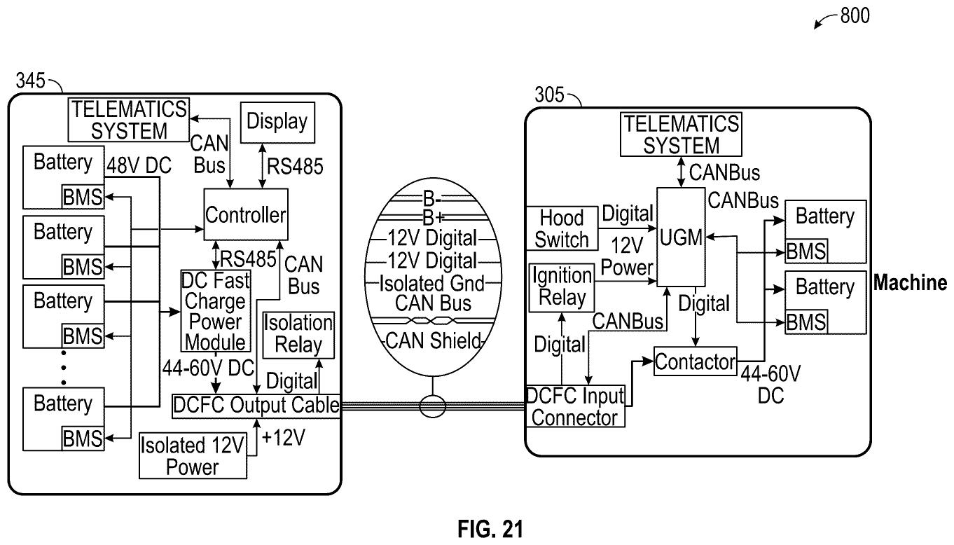

FIG. 21 depicts a schematic block diagram 800, according to some embodiments. In some embodiments, the schematic block diagram 800 may include one or more components of the system 300. For example, the schematic block diagram 800 may include the machine power system 305 and the charge system 345. FIG. 21 depicts a non-limiting example of the charge system 345 including the power source 340 (shown as battery). In some embodiments, the charge system 345 may be housed within and/or included in a generator system. For example, the charge system 345 may be included in a portable generator. The charge system 345 is shown to include a Direct Current (DC) charge power module, a controller, a display, an isolation relay, a DC Fast Charge (FC) output cable, a telematics system (e.g., an external platform), and an isolated power source. In some embodiments, the one or more components of the charge system 345, as shown in FIG. 21, may include similar components to that of the various systems and/or devices described herein. In some embodiments, the telematics system facilitates communication between the systems of the lift device 10 and a remote system. By way of example, the remote system may receive the data relating to the lift device 10 via the telematics system. The remote system may be configured to perform back-end processing of the lift device data. The remote system may be configured to transmit information, data, commands, and/or instructions to the lift device 10. By way of example, the remote system may send, via the telematics system, commands or instructions to the lift device 10 to implement.

As shown in FIG. 21, the charge system 345 and the machine power system 305 may be communicably coupled with one another via the DCFC output cable and the DCFC input cable. In some embodiments, the DCFC output cable may refer to and/or include the first power connector 108. In some embodiments, the DCFC input cable may refer to and/or include the second power connector 132.

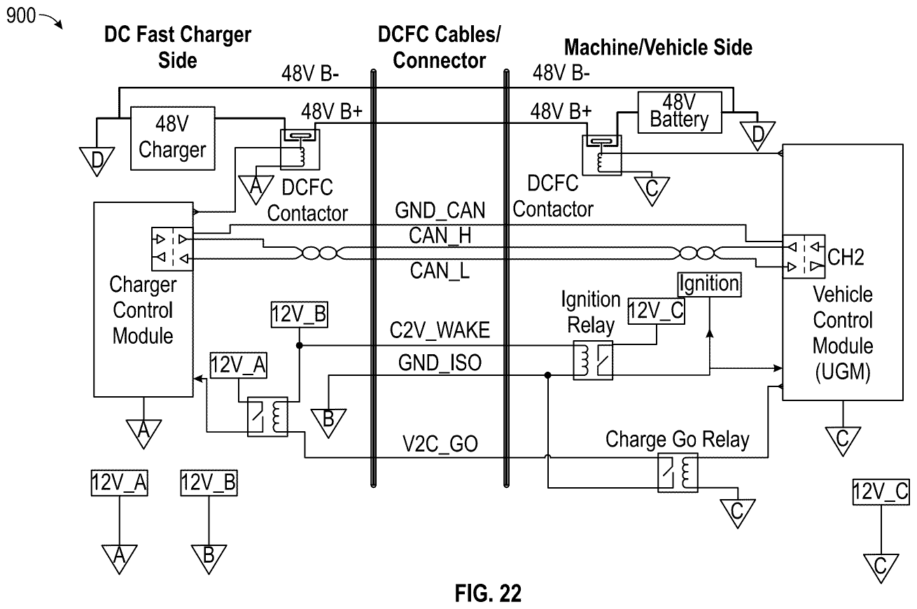

FIG. 22 depicts a schematic block diagram 900, according to some embodiments. In some embodiments, the schematic bloc diagram 900 may identify, illustrate, and/or indicate at least one of the various signals described herein. For example, in FIG. 22, the schematic block diagram 900 is shown to include the C2V signals described herein. FIG. 22 depicts a non-limiting example of one or more relays and/or switches that may be implemented within the charge system 345 and/or the machine power system 305. For example, the machine power system 305 and the charge system 345 are both shown to include a DCFC contactor, as shown in FIG. 22. In some embodiments, the DCFC contactors may isolate and/or separate the batteries 64 from the power source 340.

In some embodiments, the schematic block diagram 900 may include a CANbus and the machine power system 305 may communicate with the charge system 345 via the CANbus. For example, the machine power system 305 may provide, via the CANbus, charging parameters to the charge system 345. As shown in FIG. 22, the UGM (e.g., the controller 310) is shown to be communicably coupled with a charger control module (e.g., a controller of the charge system 345) via the CANbus. In some embodiments, the various connections illustrated in FIG. 22 may be created and/or established responsive to connecting and/or coupling the first power connector 108 with the second power connector 132.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and system 100 as shown in the various exemplary embodiments is illustrative only. Additionally, any element disclosed in one embodiment may be incorporated or utilized with any other embodiment disclosed herein. For example, the construction of the system of the exemplary embodiment shown in at least FIGS. 6-13, 15, 16, 21, and 22 may be incorporated in the lift device 10 of the embodiment shown in at least FIG. 1. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle comprising:
an energy storage device;
a door configured to move between an open position and a closed position relative to the vehicle;
an onboard power connector electrically coupled with the energy storage device, wherein an external power connector electrically coupled with an external power source is configured to couple with the onboard power connector to facilitate transferring electrical energy from the external power source to the energy storage device; and
a controller configured to:
monitor a position of the door; and
limit the transfer of electrical energy from the external power source to the energy storage device when (i) the external power connector is coupled with the onboard power connector and (ii) the door is in the open position.

2. The vehicle of claim 1, wherein limiting the transfer of electrical energy from the external power source to the energy storage device includes preventing the transfer of electrical energy from the external power source to the energy storage device.

3. The vehicle of claim 1, wherein the controller is configured to permit the transfer of electrical energy from the external power source to the energy storage device when (i) the external power connector is coupled with the onboard power connector and (ii) the door is in the closed position.

4. The vehicle of claim 1, further comprising a sensor configured to facilitate detecting the position of the door and provide a signal to the controller indicative of the position of the door.

5. The vehicle of claim 4, further comprising an interference member coupled with the door, wherein the sensor is configured to detect an absence of the interference member when the door is in the open position such that the controller limits the transfer of electrical energy from the external power source to the energy storage device.

6. The vehicle of claim 5, wherein the sensor is configured to detect a presence of the interference member when the door is in the closed position such that when (i) the external power connector is coupled with the onboard power connector and (ii) the door is in the closed position, the controller limits the transfer of electrical energy from the external power source to the energy storage device.

7. The vehicle of claim 6, wherein the sensor is a proximity switch.

8. The vehicle of claim 4, wherein the sensor is a limit switch, and wherein the controller is configured to configured to limit the transfer of electrical energy from the external power source to the energy storage device in response to at least a portion of the door contacting the limit switch.

9. The vehicle of claim 1, wherein the door provides access to the onboard power connector in the open position.

10. The vehicle of claim 1, wherein when (i) the external power connector is coupled with the onboard power connector and (ii) the door is in the closed position, the door inhibits an operator from disconnecting the external power connector from the onboard power connector.

11. The vehicle of claim 1, wherein the door includes a cutout to permit a wired cable assembly coupling the external power connector electrically with the external power source to pass through the door when (i) the external power connector is coupled with the onboard power connector and (ii) the door is in the closed position.

12. A control system for a vehicle comprising:
one or more processing circuits configured to:
determine, responsive to detection of a connector, that the vehicle is electrically coupled with a power source via the connector, the power source configured to provide power to charge a battery of the vehicle;
receive, via the connector, from the power source, a first signal to initiate charging of the battery;
transmit, via the connector, to the power source, a second signal to indicate a first plurality of parameters to define a first amount of power to receive from the power source;
electrically couple, via the connector, the battery with the power source to charge the battery using the first amount of power;
detect that a component of the vehicle has moved from a first position to a second position; and
transmit, via the connector, to the power source, a third signal to indicate a second plurality of parameters to define a second amount of power to receive from the power source.

13. The control system of claim 12, wherein the component of the of the vehicle is at least one of a hood, a door, or a cover, and wherein the one or more processing circuits are configured to detect that the component of the vehicle has moved from the first position to the second position by:
receiving, from a sensor, a fourth signal to indicate that the component moved from the first portion to the second position.

14. The control system of claim 12, the one or more processing circuits further configured to:
determine that the power source is providing the second amount of power;
transmit, via the connector, responsive to detecting that the component of vehicle has moved from the second position to the first position, a fourth signal to the power source to indicate a third plurality of parameters to define a third amount of power; and
electrically decouple the battery from the power source.

15. The control system of claim 12, wherein the connector includes:
a first portion having a first part and a second part; and
a second portion having a third part and a fourth part;
the first part configured to electrically couple with the vehicle;
the second part configured to electrically couple with the third part; and
the fourth part configured to electrically couple with the power source.

16. The control system of claim 15, wherein the component of the vehicle includes a housing to locate the second part of the first portion and the third part of the second portion with the second part of the first portion electrically coupled with the third part of the second portion.

17. The control system of claim 12, wherein the first amount of power is less than the second amount of power, and wherein the one or more processing circuits further configured to transmit, via the connector, to the power source, the second signal to indicate the first plurality of parameters to define the first amount of power to receive from the power source responsive to a determination that (i) the battery is electrically coupled with the power source via the connector and (ii) the component is in the first position.

18. A method for charging a vehicle comprising:
providing the vehicle including:
an energy storage device;
an onboard power connector electrically coupled with the energy storage device; and
a door configured to move between an open position and a closed position relative to the vehicle to provide selective access to the onboard power connector;
monitoring a position of the door;
determining whether the door is in the open position or the closed position;
determining whether an external power connector is coupled with the onboard power connector, wherein the external power connector is electrically coupled with an external power source; and
limiting the transfer of electrical energy from the external power source to the energy storage device based on a determination that (i) the external power connector is coupled with the onboard power connector and (ii) the door is in the open position.

19. The method of claim 18, wherein limiting the transfer of electrical energy from the external power source to the energy storage device includes preventing the transfer of electrical energy from the external power source to the energy storage device.

20. The method of claim 18, wherein the vehicle includes a sensor configured to facilitate detecting the position of the door and an interference member coupled with the door, and wherein the sensor is configured to detect an absence of the interference member when the door is in the open position.
